(19) United States
(12) Patent Application Publication
(10) Pub. No.: US 2019/0065498 A1
(43) Pub. Date: Feb. 28, 2019

(54) SYSTEM AND METHOD FOR RICH CONVERSATION IN ARTIFICIAL INTELLIGENCE

(71) Applicant: CHIRRP, INC., Miami, FL (US)

(72) Inventors: Xianfeng Yuan, Falls Church, VA (US); Mallesh Murugesan, Miami, FL (US)

(73) Assignee: CHIRRP, INC., Miami, FL (US)

(21) Appl. No.: 16/110,759

(22) Filed: Aug. 23, 2018

Related U.S. Application Data
(60) Provisional application No. 62/551,280, filed on Aug. 29, 2017.

(51) Int. Cl. G06F 17/30; G06N 5/02

(52) U.S. Cl. CPC G06F 17/3043; G06F 17/30554; G06N 5/027

(57) ABSTRACT

A method and system can include for “Rich Converstation” can include receiving a search query, identifying an intent of the search query, parsing the search query to identify one or more of an entity identifier and a scope identifier where an entity identifier is a subject of the search query and the scope identifier is a scope definition associated with the search query, identifying an answer to the search query based upon a user profile and the scope definition, generating a conversation-based interaction using the scope definition, and modifying the scope definition using the conversation-based interaction and user profile. The method and system can further modify a scope definition for a future conversation-based interaction based upon a prior conversation-based interaction and the user profile and present the answer to the search query and a second answer based on the future conversation-based interaction.

### CROSS-REFERENCE TO RELATED APPLICATIONS

This application claims priority under 35 U.S.C. Section 119(e) to U.S. Provisional Application No. 62/551,280 filed on Aug. 29, 2017, the entire content of which is incorporated herein by reference.

### FIELD OF THE DISCLOSURE

The present disclosure generally relates to systems and methods for providing artificial intelligence, and more particularly relates to an innovative system and related method to render Human-like conversations by an artificial intelligence engine/agent by incorporating specific methodologies to improve and enhance the accuracy of user intents and user conversations by putting intention of the user into controlled scope and providing better accuracy in identifying intention.

### BACKGROUND

In artificial intelligence, there are several components that make a machine knowledgeable to be able to respond to user requests as data. A first component is understanding the context and the knowledge base of that data. Once the machine learns and understands the data and creates context and insights from a collection of documents and data, it can answer questions intelligently on that data set. Most Artificial Intelligence (AI) agents, use machine learning algorithms to detect “signals” or patterns in the data. Users can load their data and document collection into the service, train a machine learning model based on known relevant results, then leverage this model to provide improved results (generally known as “Retrieve and Rank” to their end users based on their question or query (Ex: an experienced technician can quickly find solutions from dense product manuals). We will refer to this as “query based interaction”. In short, query based interaction is where the user asks a question and the system responds with the relevant results based on machine learning.

The second component to providing relevant responses and meaningful dialog with the user is through structured questions. In this model, a structured question and answer model is created that will take the user thru a standard set of questions to a final decision point to provide the best possible personalized answer to the user. This type of conversation based interaction is where the system asks questions to the user to understand the intent of the user further based on a specific scenario (commonly known as “Conversation”). We will refer to this as “conversation based interaction.”

### BRIEF DESCRIPTION OF DRAWINGS

FIG. 1 is a flow chart of a method of rich conversation in accordance with an embodiment;

FIG. 2 is a high level structure block diagram of a system using the method of FIG. 1 in accordance with an embodiment;

FIG. 3 is a flow chart of a method of controlled scoping of interactions in accordance with an embodiment;

FIG. 4 is a block diagram of a system illustrating interactions among query-based interaction modules and conversation-based interaction module in accordance with an embodiment;

FIG. 5 is a block diagram illustrating a flow of controlled scoping of interactions in accordance with an embodiment;

FIG. 6 illustrates a system for rich conversations in accordance with an embodiment.

### DETAILED DESCRIPTION

In the current state of the art, artificial intelligence conversations are very basic and do not have the robust nature of human conversations. This is because of several reasons:

1) Cognitive conversation is not mature to handle robust dialogs;

2) Intent identification is a challenge in the cognitive world;

3) Knowledge about the user is limited to a single conversation and does not transfer to other conversations; and

4) History of user preferences, likes, etc. are not used in conversation to provide more human like personalized interaction.

There is a current need in the art for a system and related method for providing rich conversations in artificial intelligence that will provide solutions to the above list. It would be desirable for such a system and related method to clearly define query based interaction and conversation based interaction, thereby making the building of each conversation easier. By having a smooth transition between the components, a much richer conversation can be built. A robust conversation methodology is of high need in the artificial intelligence space as enterprises are moving towards AI based customer service and engagement. In order for enterprises to provide the best relevant customer service, much more robust conversations and a high level of understanding of intents is desired.

Where query based interactions and conversation based interaction, as discussed above, operate independently and there is no logical connection between the two, embodiments herein provide the capability to start a conversation in query based component and switch to conversation based component based on user queries and have controlled scope to identify intents accurately. We call this “rich conversation”. This enables the user to have a more enhanced and a more human like conversation with the cognitive system by seamlessly switching between query based interaction to a conversation based interaction and controlling the scope of the conversation. This controlled scope of the conversation provides further relevance and accuracy to the conversation. When we look at human conversations, it is a combination of several things: 1. Understanding who the user is, 2. Asking relevant questions 3. Providing appropriate answers 4. Knowing the context of the conversation and the current and past history of the conversation. In order for machines to simulate human conversation, the above mentioned points are critical and need to be incorporated into an AI system. The present system and method of “rich conversation” is the only platform that provides a solution that encapsulates the above mentioned bullets (1 through 4). This is done by creating controlled smaller scope, implementing user variable, seamlessly transitioning between scopes, query based and Conversation based interactions and using current and past history of the conversation. These will be explained in detail below.

Rich conversation is focused on building human-like conversation instead of just understanding human language.

In addition to combining query based and conversation based interaction, rich conversation can understand user intents easily. Intention recognition is a branch of artificial intelligence, it is the process of a computer system becoming aware of the goals of one or more users by observing and analyzing the queries. In Rich conversation, there is a clear separation between multiple smaller scope components of conversation and clear entry and exit criteria between them. So when a user poses a question or provides a response, the system assumes that the user response is within the current scope until a clear entry/exit criteria is met. This significantly improves accuracy of response, thereby improving user experience. The system provides an intelligent persistence in memory and scope to determine the appropriate context as the system transitions between query based interactions and conversation based interactions.

By creating structured questions, the user is taken thru a standard set of questions and thereby the intent is more focused. Conversation based interaction is built with the premise of having workflow and scenario based conversations with the system leading the user to a specific answer or call to action. But the conversation module has its limitations. Conversation based interaction is stateless (i.e. once a conversation has ended, these variables will be lost). This existing system forces the system to ask these questions again in order to know about the user.

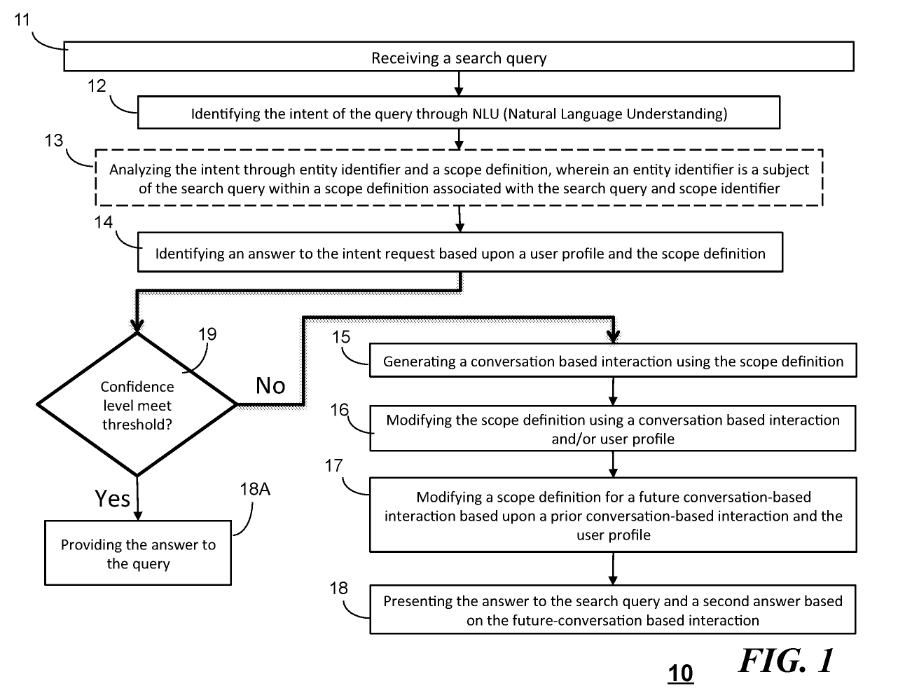

Referring to FIG. 1, a flow chart is shown illustrating a method 10 in accordance with the embodiments. In some embodiments, the method 10 can begin with a step 11 of receiving a search query or other form of query. At step 12, the method can identify an intent of the query through, for example, natural language understanding (NLU). The search query is then parsed and/or analyzed at step 13 to analyze the intent of the query by identifying one or more of an entity identifier and a scope identifier or definition. The entity identifier can be the subject of the search query within a scope definition associated with the search query and scope identifier. At step 14, the method identifies an answer to the search query based upon a user profile and the scope definition. At decision block 19, if a confidence level meets or exceeds a predetermined threshold that the answer is correct, then the method can simply provide the answer to the query at step 18A. If the confidence level fails to meet the predetermined threshold level at decision block 19, then the method can generate a conversation-based interaction using the scope definition at step 15. Based on the responses the system receives from a user from the conversation-based interaction, the scope definition can be modified at step 16 based on the conversation based interaction and/or a user profile. As will be further explained below, universal variables and session variables can be retained or can persist among different conversations (whether query-based or conversation-based) such that context and scoping can be appropriately modified (and likely improved from one session to the next using artificial intelligence). Thus, the method can modify a scope definition for a future conversation-based interaction based upon a prior conversation-based interaction and/or user profile at step 17. Assuming the user profile retains or tracks the contexts of prior interactions, the user profile can be a storage mechanism to improve future interactions. Otherwise, other databases or storage mechanisms can be used to retain user level variables, universal variables, session variables, and scope definitions as appropriate from one interaction to the next for a particular user or a set of users. At step 18, the method can present the answer to a search query and additional or second answers based on the future conversation-based interaction(s). Thus, as previously stated, the system provides an intelligent persistence in memory and scope to determine the appropriate context as the system transitions between query based interactions and conversation based interactions.

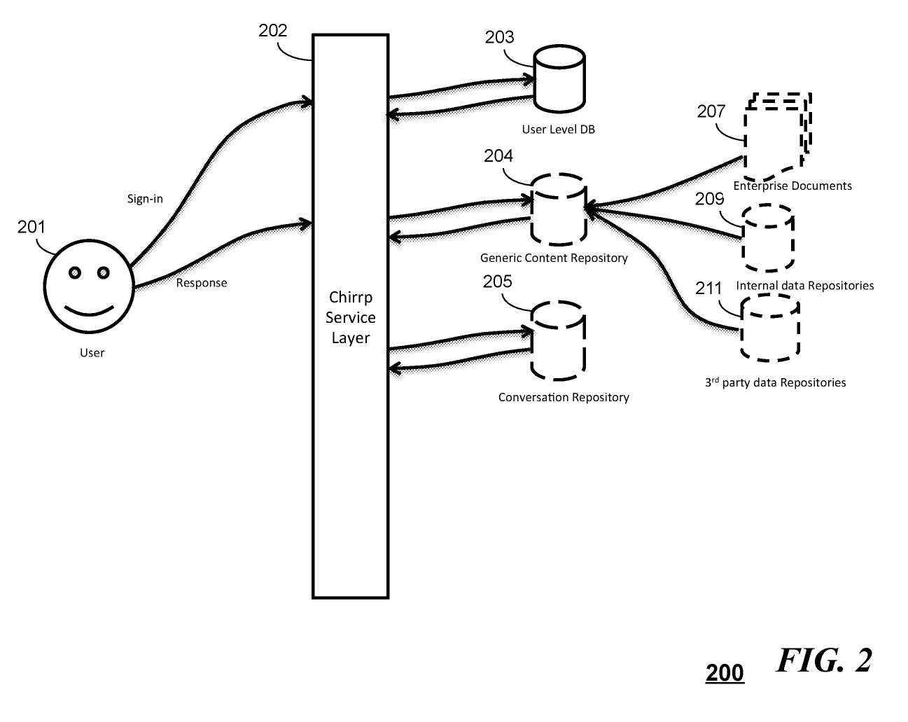

Referring to FIG. 2, a proposed “Chirrp” platform 200 handles a conversation based interaction using a “universal variable” concept wherein when a user related question presented by a user 201 is answered, the answer is stored in a user based variable independent of where in the conversation the user is in. This enables, this variable to be utilized within or outside that specific conversation in the future. These variables are universal and can be utilized in any conversation on a per needed basis. This ability to go between conversations and retain user level variables and information is unique. As an example: In a health related conversation, if the users answers that their age range is in the 50's, that information is used in other areas (or other conversations) to provide questions related to that age range. This scenario helps with streamlining the conversation and making it more relevant to the user.

Such a system can include a service layer 202 that interfaces with at least a user level database 203 that can maintain a user profile for example. The service layer 202 can further interface with a generic content repository 204 that is further coupled to other sources of data such as enterprise documents 207, internal data repositories 209, and/or third party or external data repositories 211. The context and scoping of the conversations can also be maintained via an interface between the service layer 202 and a conversation repository 205.

Key features of the system of such a system in accordance with the embodiments can include:

a) Separation of query based and dialog based conversation

b) Smooth transition between the components by using exit and entry criteria.

c) Accurate identification of intent thru smaller scope

d) Knowledge about the user

e) user-level variables

f) session variables

g) scope level (content) variables

h) universal variables

The embodiments disclosed are unique in that the structure and the utilization of the APIs are done in a way to provide better conversations with the user. Although the technologies individually exist, the creation of the structure and the methodology is unique.

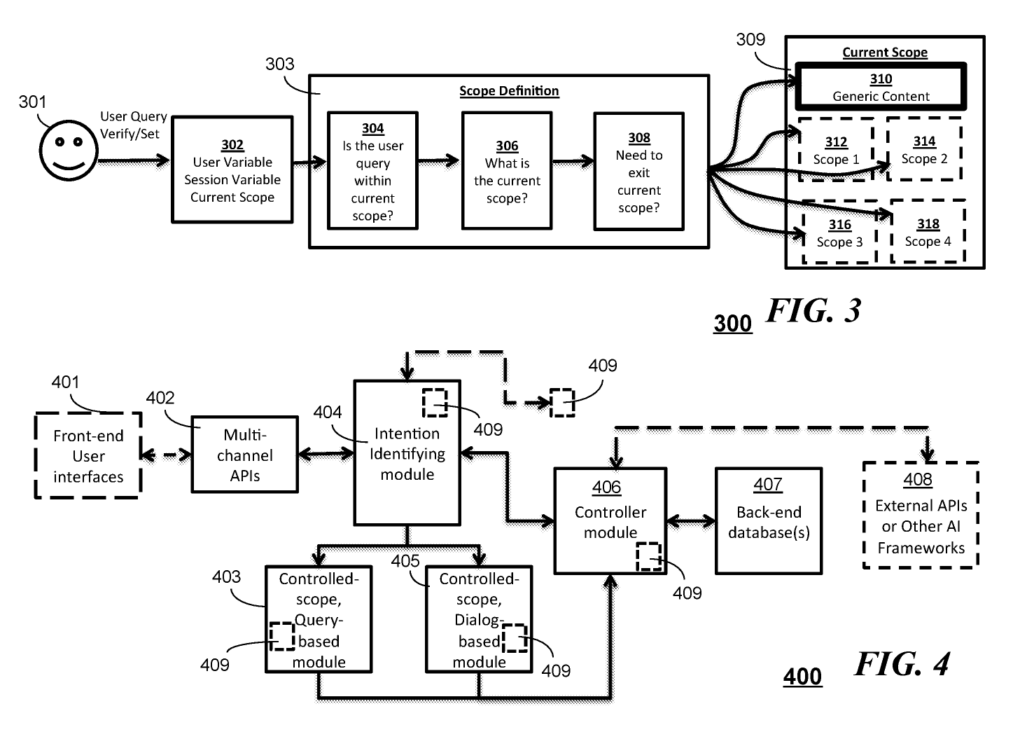

Referring to FIG. 3, a system 300 in accordance with the embodiments can have a user 301 initiate query-based interaction where a user variable, a session variable, and a current scope is maintained at a module 302. An intention identifying module 303 that can provide a scope definition can determine if a current user query is within a current user scope at 304, whether the scope is not the current user scope at 306 (“what is the current scope”), and whether the intention is to exit the current scope at 308. The current scope database 309 tracks and provides the appropriate information based on generic content 310 or other defined scopes (312, 314, 316, or 318) as the method progresses and refines the scope definition through the various interactions herein.

In AI, the knowledge base is looked at as a large encyclopedia and user queries are analyzed to provide the right answer independent from each other. This makes understanding of the user intents very hard.

Another concept in current AI technology is taking the user through a specific set of questions without additional variable information to get to a final result. Ex: ordering flowers/pizza etc. This scenario does not provide for any exit scenarios into other conversation and so makes user experiences hard. It forces the user to complete a full conversation before moving to the next step in conversation.

In Rich conversation, we look at the entire conversation with the user as a combination of multiple small and medium scoped queries and conversations and provide intelligent ways to move between these conversations. This technique will create additional smaller interaction modules than the typical AI conversation module. This enables identification and accuracy of intents.

Rich Conversation System.

A present embodiment can be a rich conversation system 400 as illustrated in FIG. 4, an embodiment of which is made up of the following components: an intention identifying module 404; a small-scope or controlled-scope, dialog-based module 405; a small-scope or controlled-scope, query-based module 403; a linking or controller module 406; and one or more backend databases 407. In system embodiments, the modules and the database(s) are operatively in communication and the modules connect to the database to retrieve user level information including but not limited to profile information and previous conversation information.

The intention identifying module 404 handles the all the user responses and questions each time a user starts a conversation.

The implementation of small scope of conversation is different than usual identifying entities methodologies used in regular searches. The conversation scope is identified by the current controlled scope the user is in, which could be a single previous response or several previous dialogs or conversations.

The user responses are passed through (Natural Language Understanding) NLU 409 (which can exist as an independent module or be part of one or more of the intention identifying module 404, linking or controller modules 406, or other aforementioned modules) to derive the meaning of the responses before scope of conversation is determined.

Each response from the user is checked for one of the 3 following critierias:

a) If conversation is in one scope, it will stay in the scope until the exit criteria is met

b) Is there an exit criteria (ex: Quit, stop etc)

c) Is the response looking for a completely new scope.

The small-scope, dialog-based module 405 handles dialog based conversation in small scope.

This module will have a well-defined set of exit criteria, including but not limited to:
a) All system based questions are answered
b) Session expired
c) User triggered exit; or
d) Rating from a common NLU service can be used for exiting scope. The system can send the input from the user to both small scope and large scope of the common NLU service at the same time from the dialog based module 405, and the common NLU service would return the rating of response from both NLU services. If the Intention Identifier shows that the user has a lot higher rate on larger scope than the current scope, the system exits the current scope.

The small-scope, query-based module 403 handles query based conversation in small scope. This module will have a well-defined set of exit criteria, including but not limited to:
a) Rating from a common NLU service can also be an important factor in the determination of exiting scope for the query based module 403. The system can send the input from the user to both small scope and large scope of the common NLU service of the query based module 403 at the same time, and the common NLU service would return the rating of response from both NLU services. If the Intention Identifier shows that user has a lot higher rate on larger scope than the current scope, then the system exits the current scope.
b) Session expired
c) User uses a keyword to exit (Ex: Quit, Stop etc.)

The linking or controller module 406 links between the different types of modules that establish relationship between various components of the rich conversation including but not limited to query based and conversation based interactions, small scope components, database calls for user information etc.

The one or more backend databases support, for example, user information and conversation history.

Further embodiments may be augmented by utilizing multiple external APIs or other AI frameworks 408 such as API.AI, IBM Watson APIs. For example, a Speech to Text and Text to Speech AI engine will allow the user to have a conversation through voice. This makes the rich conversation more powerful as the voice based conversation mimics human conversation very closely. Another embodiment contemplates working with additional AI based technologies to enhance the context of data and create intelligence from the data. Yet another embodiment contemplates a front-end user interface 401 (via multi-channel or generic APIs 402 as required) that is a component of rendering these rich conversations to the user. Multiple channels can be used, including but not limited to, Facebook Messenger, Skype, Slack, Amazon Alexa, Native app, or a Web interface.

Enterprise data is a component of rich conversation. Embodiments may also integrate with enterprise data to provide answers to user queries. Enterprise data will be consumed and controlled scope will be created from that data. Embodiments of the rich conversation system may also integrate with external APIs to enhance the capabilities of the conversation.

Example: When a question “Where is the Lincoln Memorial?” is asked, other AI technologies will look through its vast amounts of data and answer the question that has the highest confidence level. Rich conversation will look through its data and find the “Lincoln Memorial” scope and will answer it from within that scope. So, when a follow up question like “What time does it open?” is asked, other AI technologies will not know what “it” is associated with. With Rich conversation, since the scope is Lincoln Memorial, rich conversation will be able to identify “it” to be “Lincoln Memorial”. If an additional question is asked “What street is it on?”, rich conversation will still be able to answer it accurately as the scope is still in Lincoln Memorial. This scope will be kept until an exit criterion is met at which point, the user will be taken to another scope.

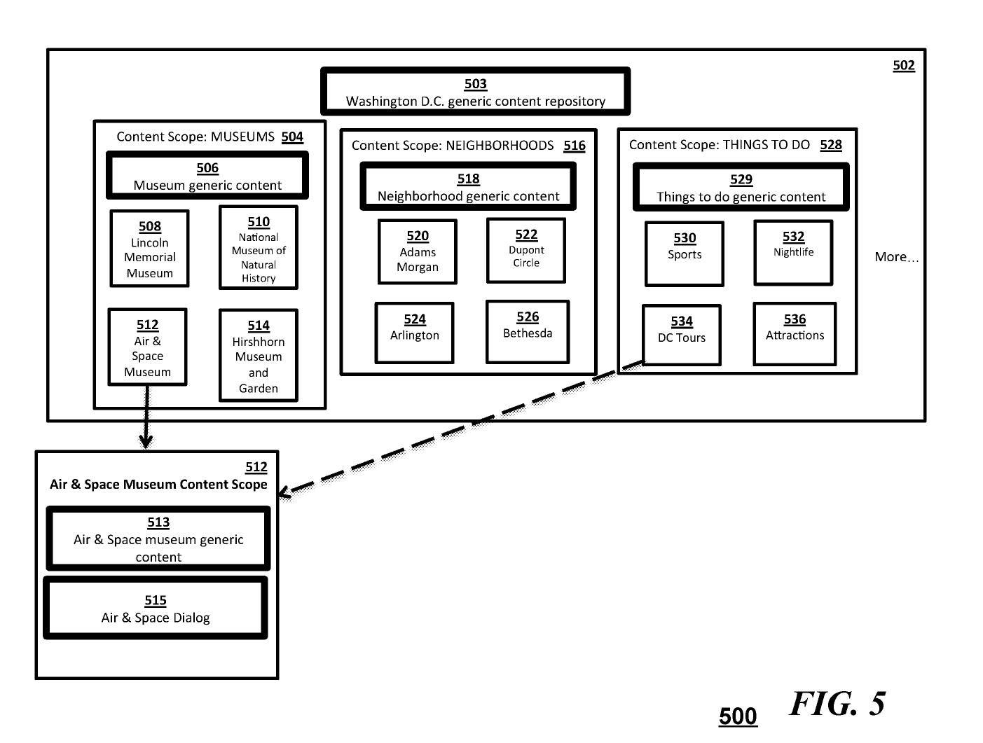

Another feature that makes rich conversation unique, is identifying entry points into the conversation as illustrated in the scoping chart 500 of FIG. 5. When a question “What are the best tours in DC?” is asked, instead of providing a list of tours, rich conversation linking module will identify it to be an entry criteria into a control scoped conversation and will take the user into a controlled scope conversation and so will kick it off by responding with a conversational query Ex: “What would you like to see?” If the response is science museums, then the system may respond with relevant and appropriate information that fits within a new controlled scope such as the Air & Space Museum content scope 512 instead of generic content for DC from repository 503 or other unrelated content based on neighborhoods (516-526) or based on things to do (528-536). (Unrelated content based on neighborhoods with various scopes can include for example neighborhood generic content 518 or neighborhood content for specific neighborhoods such as Adams Morgan 520, Dupont Circle 522, Arlington 524 or Bethesda 526. Unrelated content with various scopes based on “Things to do” can include for example Things to do generic content 529, or Sports 530, or Nightlife 532, or DC Tours 534, or Attractions 536. The system can also include a weighting algorithm or a cross-referencing system that will ultimately still lead to the appropriate Air & Space museum content scope (for example, the DC Tours 534 content under the Things to Do Scope 528 can be cross referenced to scope 512). Based on recognition of key words and context such as “science museums” and “day tour”, the appropriate scoping through Museums 504 and the air & space museum 512 will be provided instead of other generic museum content 506 or other unrelated museum content (508 related to the Lincoln Memorial Museum, 510 related to the National Museum of Natural History, or 514 related to the Hirshhorn Museum and Garden) unrelated to the current scope. Within the current scoping of the Air & Space Museum content scope 512, the system can then provide Air & Space museum generic content 513 or provide an Air & Space museum dialog 515 to further refine the scoping of the information being provided to the user.

Further aspects of embodiments can include:
a) having the capability to consume enterprise data and create controlled scope components from that data,
b) consuming data from other public sources (news, social etc) and enhance user profile variables
c) Ability to direct the call to a human if needed on a rule based criteria.

Various embodiments of the present disclosure can be implemented on an information processing system. The information processing system is capable of implementing and/or performing any of the functionality set forth above. Any suitably configured processing system can be used as the information processing system in embodiments of the present disclosure. The information processing system is operational with numerous other general purpose or special purpose computing system environments, networks, or configurations. Examples of well-known computing systems, environments, and/or configurations that may be suitable for use with the information processing system include, but are not limited to, personal computer systems, server computer systems, thin clients, hand-held or laptop devices, multiprocessor systems, mobile devices, microprocessor-based systems, set top boxes, programmable consumer electronics, network PCs, minicomputer systems, mainframe computer systems, Internet-enabled television, and distributed cloud computing environments that include any of the above systems or devices, and the like.

For example, a user with a mobile device may be in communication with a server configured to implement the rich conversation system, according to an embodiment of the present disclosure. The mobile device can be, for example, a multi-modal wireless communication device, such as a “smart” phone, configured to store and execute mobile device applications (“apps”). Such a wireless communication device communicates with a wireless voice or data network using suitable wireless communications protocols. The user signs in and access the rich conversation service layer, including the various modules described above. The service layer in turn communicates with various databases, such as a user level DB, a generic content repository, and a conversation repository. The generic content repository may, for example, contain enterprise documents, internal data repositories, and 3^{rd} party data repositories. The service layer queries these databases and presents responses back to the user based upon the rules and interactions of the rich conversation modules.

The rich conversation system may include, inter alia, various hardware components such as processing circuitry executing modules that may be described in the general context of computer system-executable instructions, such as program modules, being executed by the system. Generally, program modules can include routines, programs, objects, components, logic, data structures, and so on that perform particular tasks or implement particular abstract data types. The modules may be practiced in various computing environments such as conventional and distributed cloud computing environments where tasks are performed by remote processing devices that are linked through a communications network. In a distributed cloud computing environment, program modules may be located in both local and remote computer system storage media including memory storage devices. Program modules generally carry out the functions and/or methodologies of embodiments of the present disclosure, as described above.

In some embodiments, a system includes at least one memory and at least one processor of a computer system communicatively coupled to the at least one memory. The at least one processor can be configured to perform a method including methods described above.

According yet to another embodiment of the present disclosure, a computer readable storage medium comprises computer instructions which, responsive to being executed by one or more processors, cause the one or more processors to perform operations as described in the methods or systems above or elsewhere herein.

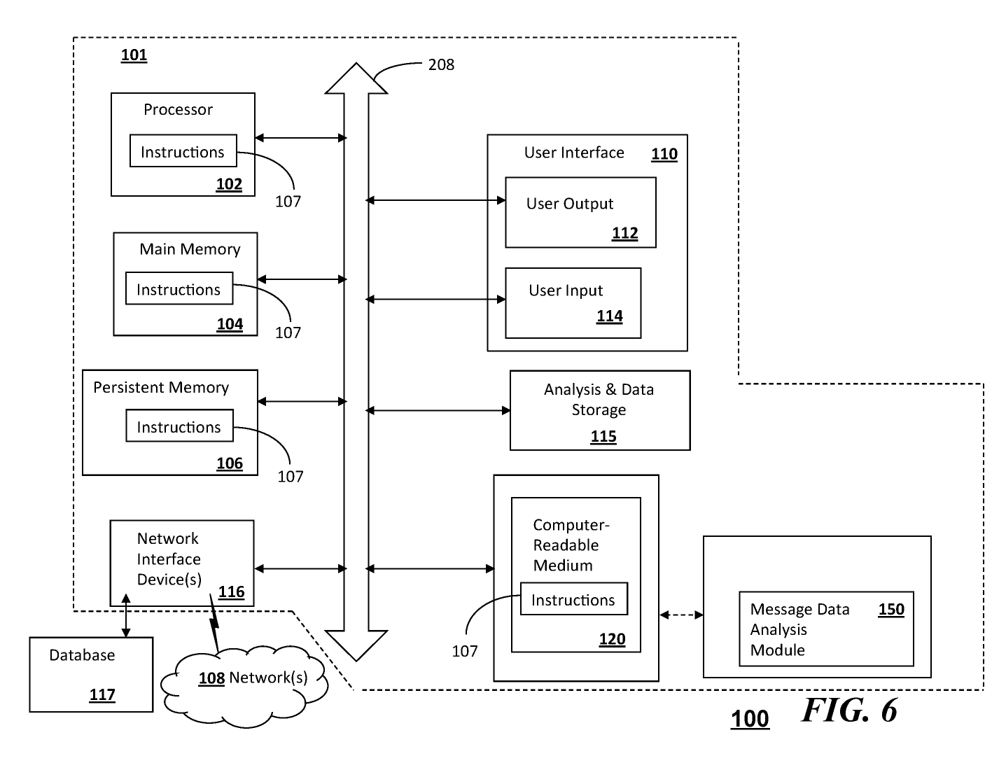

As shown in FIG. 6, an information processing system 101 of a system 100 can be communicatively coupled with the message data analysis module 150 and a group of client or other devices, or coupled to a presentation device for display at any location at a terminal or server location. According to this example, at least one processor 102, responsive to executing instructions 107, performs operations to communicate with the data analysis module 150 via a bus architecture 208, as shown. The at least one processor 102 is communicatively coupled with main memory 104, persistent memory 106, and a computer readable medium 120. The processor 102 is communicatively coupled with an Analysis & Data Storage 115 that, according to various implementations, can maintain stored information used by, for example, the message data analysis module 150 and more generally used by the information processing system 100. Optionally, this stored information can be received from the client or other devices. For example, this stored information can be received periodically from the client devices and updated or processed over time in the Analysis & Data Storage 115. Additionally, according to another example, a history log can be maintained or stored in the Analysis & Data Storage 115 of the information processed over time. The message data analysis module 150, and the information processing system 100, can use the information from the history log such as in the analysis process and in making decisions related to determining whether data measured is considered an outlier or not.

The computer readable medium 120, according to the present example, can be communicatively coupled with a reader/writer device (not shown) that is communicatively coupled via the bus architecture 208 with the at least one processor 102. The instructions 107, which can include instructions, configuration parameters, and data, may be stored in the computer readable medium 120, the main memory 104, the persistent memory 106, and in the processor's internal memory such as cache memory and registers, as shown.

The information processing system 100 includes a user interface 110 that comprises a user output interface 112 and user input interface 114. Examples of elements of the user output interface 112 can include a display, a speaker, one or more indicator lights, one or more transducers that generate audible indicators, and a haptic signal generator. Examples of elements of the user input interface 114 can include a keyboard, a keypad, a mouse, a track pad, a touch pad, a microphone that receives audio signals, a camera, a video camera, or a scanner that scans images. The received audio signals or scanned images, for example, can be converted to electronic digital representation and stored in memory, and optionally can be used with corresponding voice or image recognition software executed by the processor 102 to receive user input data and commands, or to receive test data for example.

A network interface device 116 is communicatively coupled with the at least one processor 102 and provides a communication interface for the information processing system 100 to communicate via one or more networks 108. The networks 108 can include wired and wireless networks, and can be any of local area networks, wide area networks, or a combination of such networks. For example, wide area networks including the internet and the web can inter-communicate the information processing system 100 with other one or more information processing systems that may be locally, or remotely, located relative to the information processing system 100. It should be noted that mobile communications devices, such as mobile phones, Smart phones, tablet computers, lap top computers, and the like, which are capable of at least one of wired and/or wireless communication, are also examples of information processing systems within the scope of the present disclosure. The network interface device 116 can provide a communication interface for the information processing system 100 to access the at least one database 117 according to various embodiments of the disclosure.

The instructions 107, according to the present example, can include instructions for monitoring, instructions for analyzing, instructions for retrieving and sending information and related configuration parameters and data. It should be noted that any portion of the instructions 107 can be stored in a centralized information processing system or can be stored in a distributed information processing system, i.e., with portions of the system distributed and communicatively coupled together over one or more communication links or networks.

FIGS. 1-4 illustrate examples of methods or process flows, according to various embodiments of the present disclosure, which can operate in conjunction with the information processing system 100 of FIG. 6.

What is claimed is:

1. One or more computer-storage media having computer-executable instructions embodied thereon that, when executed by one or more computing devices, perform a method, the method comprising:
receiving, via a user input coupled to the one or more computing devices, a search query in a query-based interaction;
parsing, by the one or more computing devices, the search query to identify one or more of an entity identifier and a scope identifier, wherein an entity identifier is a subject of the search query and the scope identifier is a scope definition associated with the search query;
identifying, by the one or more computing devices, an answer to the search query based upon a user profile and the scope identifier;
generating, by the one or more computing devices, a conversation-based interaction using the scope definition;
modifying, by the one or more computing devices, the scope definition using the conversation-based interaction and user profile;
modifying, by the one or more computing devices, a scope definition for a future conversation-based interaction based upon a prior conversation-based interaction;
presenting, via a user output device coupled to the one or more computing devices, the answer to the search query and a second answer based on the future conversation-based interaction.

2. The media of claim 1, wherein the search query is a text input or a voice input.

3. The media of claim 1, wherein the answer is displayed in combination with one or more web search results or in combination with an artificial intelligence based framework.

4. The media of claim 1, wherein the scope definition persists among and between query-based interactions and conversation-based interaction until an intention identifying module determines that the scope definition has changed based on a defined set of exit criteria.

5. The media of claim 1, further comprising maintaining user level universal variables across different query based interactions and conversation based interactions.

6. A computerized method, the method comprising:
receiving via a user input coupled to one or more computing devices a search query;
identifying by the one or more computing devices an intent of the search query;
parsing by the one or more computing devices the search query to identify one or more of an entity identifier and a scope identifier, wherein an entity identifier is a subject of the search query within a scope definition associated with the search query and scope identifier;
identifying by the one or more computing devices an answer to the search query based upon a user profile and the scope definition;
generating by the one or more computing devices a conversation-based interaction using the scope definition;
modifying by the one or more computing devices the scope definition using the conversation-based interaction and user profile;
modifying by the one or more computing devices a scope definition for a future conversation-based interaction based upon a prior conversation-based interaction and the user profile;
presenting via a user output device coupled to the one or more computing devices the answer to the search query and a second answer based on the future conversation-based interaction.

7. The method of claim 6, wherein the method stores a user-level universal variable in a user profile and further stores a universal context variable for the user.

8. The method of claim 6, wherein the method maintains a scope definition within a query based interaction or a conversation based interaction until a defined exit criteria is met.

9. The method of claim 6, wherein query based interactions and conversation based interactions are linked.

10. A system, comprising:
a memory having computer instructions stored therein;
one or more processors coupled to the memory, wherein the one or more processors upon execution of the computer instructions cause the one or more processors to perform the operations comprising:
receiving a search query;
identifying an intent of the search query;
parsing the search query to identify one or more of an entity identifier and a scope identifier, wherein an entity identifier is a subject of the search query and the scope identifier is a scope definition associated with the search query;
identifying an answer to the search query based upon a user profile and the scope definition;
generating a conversation-based interaction using the scope definition;
modifying the scope definition using the conversation-based interaction and user profile;
modifying a scope definition for a future conversation-based interaction based upon a prior conversation-based interaction and the user profile;
presenting the answer to the search query and a second answer based on the future conversation-based interaction.

11. The system of claim 10, wherein a current scope of a conversation based interaction is modified based on a universal user variable and a session variable stored in the memory or stored in a second memory.

12. The system of claim 10, wherein the system comprises an intention identifying module, a dialog based module, a query based module, a linking module, and one or more backend databases.

13. The system of claim 12, wherein the intention identifying module is configured to handle user responses and questions each time the system receives a user query.

14. The system of claim 12, wherein the dialog based module is configured to identify the current scope based upon defined exit criteria and a single previous response received by a user or based upon several previous dialogues or conversations with the user.

15. The system of claim 12, wherein the intention identifying module uses a natural language understatnding module to determine if a conversation is remaining within a current scope, if an exit criteria has been met, or if a response to a query is looking for a different scope outside the current scope.

16. The system of claim 10, wherein the one or more processors are coupled to an artificial intelleigence engine including a speech-to-text engine or a text-to-speech engine.

17. The system of claim 10, wherein the one or more processors are coupled to a front-end input engine coupled to a social media messaging application, an Internet video-conferencing application, a stand-alone internet voice processing search engine, a voice-to-chat interface, or an voice to instant messaging application.

18. The system of claim 10, wherein the system is coupled to an enterprise database which is used to control the scope definition, or is coupled to public sources of information to enhance user profile variables.

19. The system of claim 10, wherein the system is configured to redirect a conversation to a live attendant based on rule based criteria.

20. The system of claim 10, wherein the system is configure to identify the intent of the query through a natural language understanding processor.
